(19) United States
(12) Patent Application Publication
(10) Pub. No.: US 2021/0187746 A1
(43) Pub. Date: Jun. 24, 2021

(54) TASK PLANNING ACCOUNTING FOR OCCLUSION OF SENSOR OBSERVATIONS

(71) Applicant: X Development LLC, Mountain View, CA (US)

(72) Inventors: Michael Beardsworth, San Francisco, CA (US); Timothy Robert Kelch, San Jose, CA (US)

(21) Appl. No.: 16/725,620

(22) Filed: Dec. 23, 2019

(51) Int. Cl. B25J 9/16

(52) U.S. Cl. CPC B25J 9/1694; B25J 9/1684; B25J 9/1664; B25J 9/1605

(57) ABSTRACT

Methods, systems, and apparatus, including computer programs encoded on computer storage media, for planning robotic movements to capture desired sensor measurements. One of the methods includes generating a three-dimensional representation of a robotic operating environment, wherein the robotic operating environment comprises a robot and a sensor, including: generating a first three-dimensional representation of a field of view of the sensor in the robotic operating environment, and generating a second three-dimensional representation of a desired observation of an object in the robotic operating environment; generating a plurality of candidate plans for the robot; selecting, from the candidate plans, a particular candidate plan that intersects the first three-dimensional representation of the field of view of the sensor and the second three-dimensional representation of the desired observation of the object; and causing the robot to execute the particular candidate plan to make the desired observation of the object in the robotic operating environment.

### BACKGROUND

This specification relates to robotics, and more particularly to planning robotic movements.

Robotics planning refers to sequencing the physical movements of robots in order to perform tasks. For example, an industrial robot that builds cars can be programmed to first pick up a car part and then weld a car part onto the frame of the car. Each of these actions can themselves include dozens or hundreds of individual movements by robot motors and actuators.

Robotics planning has traditionally required immense amounts of manual programming in order to meticulously dictate how the robotic components should move in order to accomplish a particular task. Manual programming is tedious, time-consuming, and error prone. In addition, a plan that is manually generated for one workcell can generally not be used for other workcells. In this specification, a workcell is the physical environment in which a robot will operate. Workcells have particular physical properties, e.g., physical dimensions, that impose constraints on how robots can move within the workcell. Thus, a manually-programmed plan for one workcell may be incompatible with a workcell having different physical dimensions.

Workcells often contain more than one robot. For example, a workcell can have multiple robots each welding a different car part onto the frame of a car at the same time. In these cases, the planning process can include assigning tasks to specific robots and planning all the movements of each of the robots. Manually programming these movements in a way that avoids collisions between the robots while minimizing the time to complete the tasks is difficult, as the search space in a 6D coordinate system is very large and cannot be searched exhaustively in a reasonable amount of time.

In many industrial robotics applications, the primary success or failure criteria for a plan is the time it takes to complete a task. For example, at a welding station in a car assembly line, the time it takes for robots to complete welds on each car is a critical aspect of the overall throughput of the factory. When using manual planning, it is often difficult or impossible to predict how long the plan will take to complete the task.

### SUMMARY

This specification generally describes how a system can generate a plan for one or more robots in a workcell that satisfies requirements that one or more sensors in the workcell capture desired observations of particular objects in the workcell.

In some implementations, a robot planning system requires in-process observations of certain objects in the workcell while the robots in the workcell move to complete a task, in order to plan future movements of the robots. In-process observations can be required by any robot planning system that follows a sequence of “observe, plan, move, observe,” where the robot planning system iteratively observes the current state of the workcell and moves according to the captured observations.

As a particular example, a first robot may need to apply a glue bead to a piece of sheet metal that is not well-fixtured; that is, the piece of sheet metal is not fully supported, so that parts of the piece of sheet metal are slightly warped while the first robot is applying the glue bead. The robot planning system might generate two plans to accomplish this task: a first plan that positions the robots and the piece of sheet metal, and a second plan that executes the application of the glue bead.

The first plan can be pre-generated by the robot planning system, and can be used to position the robots in the workcell for the first robot to apply the glue bead. Then, the path of the first robot as it applies the glue bead, as well as subsequent movements of other robots in the workcell, may depend on the particular placement of the piece of sheet metal and the degree to which the piece of sheet metal is warped; these variables may be slightly different following different executions of the first plan.

The robot planning system can generate the second plan for the workcell after the robots have already been properly positioned, so that the second plan can dictate how the first robot applies the glue bead and how the other robots move around the positioned piece of sheet metal. In order to generate the second plan, the robot planning system can require up-to-date measurements of the current state of the workcell captured by one or more sensors in the workcell. The up-to-date measurements provide information about the particular placement of the piece of sheet metal and the degree to which the piece is warped to the robot planning system, so that the system can plan the movements of the robots in the second plan accordingly.

Thus, the pre-generated first plan must ensure that the piece of sheet metal is measurable by the sensors in the workcell.

In some other implementations, the sensor measurements collected by the sensors in a workcell can be sent to an external system. For example, the measurements can be displayed on a user interface device, so that a user can monitor the execution of tasks in the workcell. As another example, the measurements can be sent to an external quality control system, and the quality control system can automatically analyze the received measurements to track the quality of the execution of the tasks in the workcell. As another example, the measurements can be sent to an external safety system, and the safety system can automatically analyze the received measurements according to a set of safety metrics; if the workcell is determined to be in an unsafe state, the safety system can alert a user or another external system that can intervene.

Particular embodiments of the subject matter described in this specification can be implemented so as to realize one or more of the following advantages.

Using techniques described in this specification can dramatically reduce the amount of manual programming required in order to program robots. The system can automatically generate a plan for an arbitrary number of robots and sensors. The manual programming is made particularly difficult if robots are moving in and out of the field of view of one or more of the sensors, and so each movement and each sensor measurement must be precisely synced with each other to achieve the task while satisfying every constraint.

For some types of sensors, the interaction between the sensor and the object of interest may not be easily modeled. For example, the sensor can be a microphone that must capture sounds emitted from a particular object. The interaction with the sounds and other objects in the robotic operating environment, e.g., dampening, echoing, etc., are not straightforward. Thus, it would be extremely difficult to manually generate a plan to ensure that the microphone captures precisely the observation that is desired in such a way that the observation is interpretable. Certain techniques described in this specification allow a system to automatically generate a plan that captures each desired observation.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example system.

FIG. 2 illustrates an example workcell.

FIG. 3 is a flowchart of an example process for generating a plan.

Like reference numbers and designations in the various drawings indicate like elements.

### DETAILED DESCRIPTION

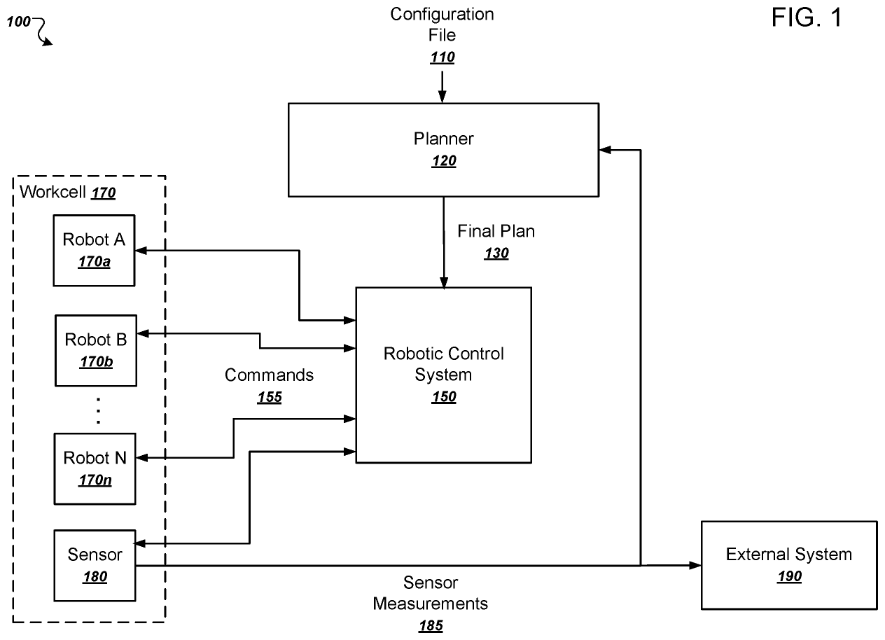

FIG. 1 is a diagram that illustrates an example system 100. The system 100 is an example of a system that can implement the techniques described in this specification.

The system 100 includes a number of functional components, including a planner 120, a robotic control system 150, and an external system 190. Each of these components can be implemented as computer programs installed on one or more computers in one or more locations that are coupled to each other through any appropriate communications network, e.g., an intranet or the Internet, or combination of networks. The system 100 also includes a workcell 170 that includes N robots 170a-n and a sensor 180.

The robotic control system 150 is configured to control the robots 170a-n in the workcell 170. The sensor 180 is configured to capture measurements of the workcell 170. The sensor 180 can be any device that can take measurements of a current state of the workcell 170, e.g., a camera, a lidar sensor, or a microphone. In some implementations, there can be multiple sensors in the workcell 170, where different sensors are of a different type, in a different position in the workcell 170, and/or differently configured than the other sensors in the workcell 170.

The overall goal of the planner 120 is to generate a plan that allows the robotic control system 150 to execute one or more tasks, while ensuring that the sensor 180 is able to capture certain desired observations of the workcell 170.

The planner 120 receives a configuration file 110. The configuration file 110 can be generated by a user. The configuration file 110 can specify the required tasks to be completed by the robots in the workcell 170. The configuration file 110 can also specify the desired observations that must be captured by the sensor 180.

For example, the configuration file 110 can specify that a particular region of the workcell 170 must be observable by the sensor 180 at all times; e.g., if the sensor 180 is a camera, the specified region must be visible to the sensor 180 throughout the execution of the plan generated by the planner 120.

As another example, the configuration file 110 can specify that a particular region of the workcell 170 must be observable by the sensor 180 at a particular time; e.g., the specified region can be the location of a particular fixture in the workcell 170, and the sensor 180 must be able to observe the fixture after a piece has been placed at the fixture but before work is done on the piece by the robots. At other times, however, the specified fixture need not be observable by the sensor 180.

As another example, the configuration file 110 can specify a particular region of the workcell 170 that must be observed from multiple angles at respective times in the execution of the plan generated by the planner 120. That is, there can be multiple sensors 180 of a similar type positioned at different locations the workcell 170, and each sensor has to capture a measurement of the particular region. In some implementations, the sensors do not necessarily have to capture the respective measurements at the same time; i.e., a first sensor can capture a respective measurement at a first time, a second sensor can capture a respective measurement at a second time, etc. Thus, even the portions of the region of the workcell 170 that are obscured from one sensor are measured by another.

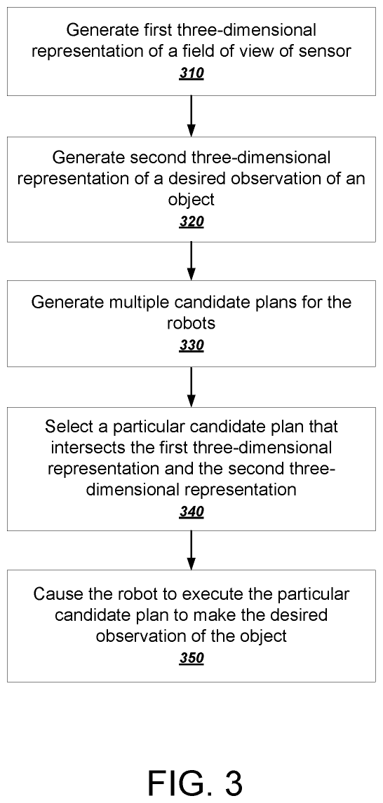

The planner 120 uses the configuration file 110 to generate a final plan 130 for the robotic control system 150 that, when executed by the robots in the workcell 170, accomplishes the tasks specified in the configuration file 110 while satisfying the sensor requirements specified in the configuration file 110. This process is described in more detail below in reference to FIG. 3. In particular, during execution of the final plan 130, the sensor 180 is able to capture all measurements that are required in the configuration file 110.

The planner 120 gives the final plan 130 to the robotic control system 150. In some implementations, the planner 120 is an offline planner. That is, the planner 120 can provide the final plan 130 to the robotic control system 150 before the robotic control system 150 executes any operations, and the planner 120 does not receive any direct feedback from the robotic control system 150. In some such implementations, the planner 120 can be hosted offsite at a data center separate from the robotic control system 150.

In some other implementations, the planner 120 can be an online planner. That is, the robotic control system can receive the final plan 130 and begin execution, and provide feedback on the execution to the planner 120. The planner 120 can respond to feedback from the robotic control system 150, and generate a new final plan in response to the feedback.

The robotic control system 150 executes the final plan by issuing commands 155 to the workcell 170 in order to drive the movements of the robots 170a-n.

The robotic control system 150 can also issue commands 155 to the sensor 180. For example, the commands 155 can identify particular times at which the sensor 180 should capture certain desired observations of the workcell 170. In some implementations, the sensor 180 can also be moved within the workcell 170. For example, the sensor 180 can be attached to a robotic arm that can move the sensor to different positions throughout the workcell 180 in order to capture certain desired observations. In these implementations, the robotic control system 150 can issue commands 155 that specify an orientation and/or position of the sensor 180 for each desired observation.

While the robots 170a-n in the workcell 170 are executing the commands 155, the sensor 180 can capture sensor measurements 185 identified in the commands 155 and send the sensor measurements 185 to other components of the system 100.

In particular, the sensor 180 can send the sensor measurements 185 to the planner 120. The planner 120 can use the sensor measurements 185 to generate a plan for subsequent movements of the robots in the workcell 170. For example, the planner 120 can use the sensor measurements 185 to know precisely where each object in the workcell 170 is currently located, and thus build a new plan for the robots in the workcell 170 to move without colliding with any other object of the workcell 170.

Instead or in addition, the sensor 180 can send the sensor measurements 185 to an external system 190. There are many external systems that might require the sensor measurements 185 captured by the sensor 180. As a particular example, the external system 190 can be a user interface device configured to allow a user to monitor the tasks executed by the robots in the workcell 170.

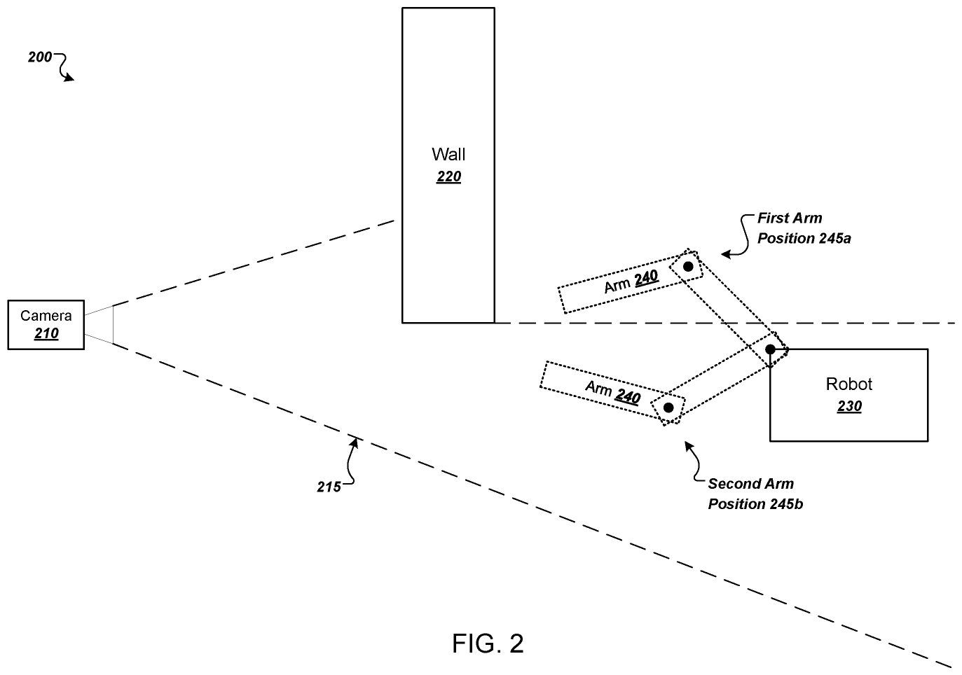

FIG. 2 illustrates an example workcell 200. The workcell 200 includes a camera 210, a wall 220, and a robot 230 that has an arm 240. According to a configuration file submitted by a user, the camera 210 must capture an observation of the arm 240 of the robot 230 after the robot 230 has completed a particular task.

The robot 230 is configured to receive commands from a control system, e.g., the robotic control system 150 depicted in FIG. 1, to accomplish the particular task. The commands can be issued according to a plan generated by a planner, e.g., the planner 120 depicted in FIG. 1, using the configuration file submitted by the user.

There are many possible candidate plans that cause the robot 230 to accomplish the particular task. For example, a first candidate plan can cause the arm 240 to end in a first arm position 245a after executing the particular task. A second candidate plan can cause the arm 240 to end in a second arm position 245b after executing the particular task.

The camera 210 has a field of view 215. The first arm position 245a is blocked from the field of view 215 by the wall 220, and therefore the camera 210 cannot capture an observation of the arm 240 if the arm 240 is in the first arm position 245a. Conversely, the arm 240 is in the field of view 215 of the camera 210 when it is in the second arm position 245b, and thus the camera 210 would be able to capture an observation of the arm 240 if it were in the second arm position 245b.

The planner that generates the plan to be executed by the robot 230 in the workcell 200 must ensure that all desired observations identified in the configuration file are able to be captured. Thus, the planner would prefer the second candidate plan, i.e., the candidate plan that results in the arm 240 being in the field of view 215 of the camera 210, over the first candidate plan, i.e., the candidate plan that results in the arm 240 being obscured from the field of view 215 of the camera 210.

There are many ways that the planner can determine whether a given position of the arm 240 is in the field of view 215 of the camera 210. As a particular example, the planner can trace the path that light takes between the camera 210 and the arm 240; if the planner can verify that such a path exists for every point on the arm 240, then the arm 240 is in the field of view of the camera 210. This technique is similar to existing “ray tracing” techniques used in some physically-based rendering technologies, e.g., “High Quality Rendering using Ray Tracing and Photon Mapping,” Jensen et al., DOI: 10.1145/1281500.1281593.

As another particular example, the planner can model the field of view 215 of the camera 210 as a three-dimensional volume, with an associated size, shape, and position in the workcell 200. Then, for each candidate arm position of the arm 240, the planner can model the arm 240 as a three-dimensional volume, also with an associated size, shape, and position in the workcell 200. If the model of the arm 240 in a particular candidate arm position fits entirely within the model of the field of view 215 of the camera 210, then the arm 240 is in field of view of the camera 210 when it is in the particular candidate arm position.

This process is discussed in more detail below in reference to FIG. 3.

FIG. 3 is a flowchart of an example process 300 for generating a plan for a robot in a robotic operating environment to accomplish a particular task while satisfying a sensor constraint. The sensor constraint can require that a sensor in the robotic operating environment capture a certain desired observation of an object in the robotic operating environment during execution of the plan. The process 300 can be implemented by one or more computer programs installed on one or more computers and programmed in accordance with this specification. For example, the process 300 can be performed by the planner 120 depicted in FIG. 1. For convenience, the process will be described as being performed by a system of one or more computers.

The system generates a first three-dimensional representation of a field of view of the sensor in the robotic operating environment (310). For example, the first three-dimensional representation can be the field of view modeled as a three-dimensional volume in the workcell. That is, every point within the modeled volume is defined to be within the field of view of the sensor. The volume can have an associated size, shape, and position in the workcell. For example, the volume can have a defined shape and six associated degrees of freedom, e.g., three degrees of freedom defining an (x,y,z) position in the workcell and three degrees of freedom defining an orientation (e.g., pitch, yaw, and roll) in the workcell.

The system generates a second three-dimensional representation of the desired observation of the object in the operating environment (320). For an example, the second three-dimensional representation can be the desired observation modeled as a three-dimensional volume, with an associated size, shape, and position in the workcell. In some cases, the desired observation will only cover a portion of the object, e.g., the desired observation might be a top view of an object, while the other sides of the object can be ignored. In this case, only the portion of the object that must be captured by the sensor will be modeled; e.g., only the points on the object that must be captured might be included in the three-dimensional volume.

The system generates multiple candidate plans for the robot (330). The goal of the candidate plans is to accomplish the particular task using the robot in the robotic operating environment while satisfying the sensor constraints. However, each candidate plan does not necessarily accomplish the task and/or satisfy the sensor constraints.

In some implementations, the system uses the first three-dimensional representation of the field of view of the sensor and the second three-dimensional representation of the desired observation of the object to generate a three-dimensional representation of a volume in the robotic operating environment in which the object is occluded from the sensor if the object is placed in the volume. The object can be occluded by one or more other objects in the robotic operating environment. Then, the system generates one or more candidate plans that avoid placing the object that must be observed within the volume in which the object would be occluded.

In some implementations, the sensor itself can be moved. For example, the sensor can be attached to an arm of the robot. In some such implementations, the system generates a three-dimensional representation of a volume in the robotic operating environment in which the object is occluded from the sensor if the sensor is placed in the volume. Then, the system generates one or more candidate plans that avoid placing the sensor within the volume in which the object would be occluded.

In some implementations, the field of view of the sensor can be occluded by another robot in the robotic operating environment. In some such implementations, the system can generate one or more candidate plans that cause the robot to wait for the other robot to move out of the three-dimensional representation of the field of view of the sensor before proceeding with other movements in the plan. In these cases, the field of view of the sensor is not static, because other robots can move in and out of the field of view, occluding other objects behind the robots. Thus, manually generating the plan for the robot, in addition to the plans for the other robots in the robotic operating environment, would be very difficult and time consuming.

In some implementations, the three-dimensional representation of the desired observation of the object is a three-dimensional volume of the object. In some such implementations, the system can generate one or more candidate plans for which, for each point on the three-dimensional volume of the object, at least one path of light exists between the point and the sensor. The path of light can be the path that light will take during a certain time interval of the plan. If the path of light exists for each point, then the object is observable by the sensor.

In some such implementations, the system can verify that a path of light exists between a given point on the three-dimensional volume of the object and the sensor by tracing the path of light from the sensor to the point. The system can simulate the effect on the path of light of one or more encounters with other objects in the robotic operating environment. For example, if there is a mirror in the robotic operating environment, the system can trace the path of light reflecting off of the mirror. As a particular example, the sensor can be a camera, and the path of light can be traced from a light source in the robotic operating environment, to the object, to the camera. As another particular example, the sensor can be a lidar sensor, and the path of light can be traced from the lidar sensor to the object, and reflected back to the lidar sensor. As described above, this technique is similar to existing “ray tracing” techniques used in some physically-based rendering technologies.

The system selects, from the generated candidate plans, a particular candidate plan that intersects the first three-dimensional representation of the field of view of the sensor and the second three-dimensional representation of the desired observation of the object (340). That is, the final plan satisfies the sensor constraint that the sensor must capture a desired observation of the object.

In some implementations, the system classifies each candidate plan as either i) a plan that achieves the desired observation, or ii) a plan that does not achieve the desired observation. The system can then select the particular candidate plan from those plans that were classified as achieving the desired observation. In some implementations, the system considers other factors in addition to the sensor constraint when selecting a particular candidate plan, e.g. time to complete the plan, risk of collision during execution of the plan, etc.

The system causes the robot to execute the particular candidate plan to make the desired observation of the object in the robotic operating environment (350). For example, the system can use a control system, e.g., the robotic control system 150 depicted in FIG. 1, to send commands to the robot in the robotic operating environment, where the commands are issued according to the particular candidate plan.

In some implementations, a sensor constraint may require that a particular object be outside of the field of view of the sensor when a certain observation is made. That is, the desired observation cannot include the particular object. For example, the object may be a robotic arm that will interfere with the sensor if the robotic arm is in the field of view of the sensor. In this case, the system can generate a three-dimensional representation of the object as before (step 320). However, when the system selects a particular candidate plan (step 340), the system selects a plan such that the three-dimensional representation of the field of view of the sensor and the three-dimensional representation of the object do not intersect when the desired observation is captured.

The robot functionalities described in this specification can be implemented by a hardware-agnostic software stack, or, for brevity just a software stack, that is at least partially hardware-agnostic. In other words, the software stack can accept as input commands generated by the planning processes described above without requiring the commands to relate specifically to a particular model of robot or to a particular robotic component. For example, the software stack can be implemented at least partially by the robotic control system 150 of FIG. 1.

The software stack can include multiple levels of increasing hardware specificity in one direction and increasing software abstraction in the other direction. At the lowest level of the software stack are robot components that include devices that carry out low-level actions and sensors that report low-level statuses. For example, robots can include a variety of low-level components including motors, encoders, cameras, drivers, grippers, application-specific sensors, linear or rotary position sensors, and other peripheral devices. As one example, a motor can receive a command indicating an amount of torque that should be applied. In response to receiving the command, the motor can report a current position of a joint of the robot, e.g., using an encoder, to a higher level of the software stack.

Each next highest level in the software stack can implement an interface that supports multiple different underlying implementations. In general, each interface between levels provides status messages from the lower level to the upper level and provides commands from the upper level to the lower level.

Typically, the commands and status messages are generated cyclically during each control cycle, e.g., one status message and one command per control cycle. Lower levels of the software stack generally have tighter real-time requirements than higher levels of the software stack. At the lowest levels of the software stack, for example, the control cycle can have actual real-time requirements. In this specification, real-time means that a command received at one level of the software stack must be executed and optionally, that a status message be provided back to an upper level of the software stack, within a particular control cycle time. If this real-time requirement is not met, the robot can be configured to enter a fault state, e.g., by freezing all operation.

At a next-highest level, the software stack can include software abstractions of particular components, which will be referred to motor feedback controllers. A motor feedback controller can be a software abstraction of any appropriate lower-level components and not just a literal motor. A motor feedback controller thus receives state through an interface into a lower-level hardware component and sends commands back down through the interface to the lower-level hardware component based on upper-level commands received from higher levels in the stack. A motor feedback controller can have any appropriate control rules that determine how the upper-level commands should be interpreted and transformed into lower-level commands. For example, a motor feedback controller can use anything from simple logical rules to more advanced machine learning techniques to transform upper-level commands into lower-level commands. Similarly, a motor feedback controller can use any appropriate fault rules to determine when a fault state has been reached. For example, if the motor feedback controller receives an upper-level command but does not receive a lower-level status within a particular portion of the control cycle, the motor feedback controller can cause the robot to enter a fault state that ceases all operations.

At a next-highest level, the software stack can include actuator feedback controllers. An actuator feedback controller can include control logic for controlling multiple robot components through their respective motor feedback controllers. For example, some robot components, e.g., a joint arm, can actually be controlled by multiple motors. Thus, the actuator feedback controller can provide a software abstraction of the joint arm by using its control logic to send commands to the motor feedback controllers of the multiple motors.

At a next-highest level, the software stack can include joint feedback controllers. A joint feedback controller can represent a joint that maps to a logical degree of freedom in a robot. Thus, for example, while a wrist of a robot might be controlled by a complicated network of actuators, a joint feedback controller can abstract away that complexity and exposes that degree of freedom as a single joint. Thus, each joint feedback controller can control an arbitrarily complex network of actuator feedback controllers. As an example, a six degree-of-freedom robot can be controlled by six different joint feedback controllers that each control a separate network of actual feedback controllers.

Each level of the software stack can also perform enforcement of level-specific constraints. For example, if a particular torque value received by an actuator feedback controller is outside of an acceptable range, the actuator feedback controller can either modify it to be within range or enter a fault state.

To drive the input to the joint feedback controllers, the software stack can use a command vector that includes command parameters for each component in the lower levels, e.g., a positive, torque, and velocity, for each motor in the system. To expose status from the joint feedback controllers, the software stack can use a status vector that includes status information for each component in the lower levels, e.g., a position, velocity, and torque for each motor in the system. In some implementations, the command vectors also include some limit information regarding constraints to be enforced by the controllers in the lower levels.

At a next-highest level, the software stack can include joint collection controllers. A joint collection controller can handle issuing of command and status vectors that are exposed as a set of part abstractions. Each part can include a kinematic model, e.g., for performing inverse kinematic calculations, limit information, as well as a joint status vector and a joint command vector. For example, a single joint collection controller can be used to apply different sets of policies to different subsystems in the lower levels. The joint collection controller can effectively decouple the relationship between how the motors are physically represented and how control policies are associated with those parts. Thus, for example if a robot arm has a movable base, a joint collection controller can be used to enforce a set of limit policies on how the arm moves and to enforce a different set of limit policies on how the movable base can move.

At a next-highest level, the software stack can include joint selection controllers. A joint selection controller can be responsible for dynamically selecting between commands being issued from different sources. In other words, a joint selection controller can receive multiple commands during a control cycle and select one of the multiple commands to be executed during the control cycle. The ability to dynamically select from multiple commands during a real-time control cycle allows greatly increased flexibility in control over conventional robot control systems.

At a next-highest level, the software stack can include joint position controllers. A joint position controller can receive goal parameters and dynamically compute commands required to achieve the goal parameters. For example, a joint position controller can receive a position goal and can compute a set point for achieve the goal.

At a next-highest level, the software stack can include Cartesian position controllers and Cartesian selection controllers. A Cartesian position controller can receive as input goals in Cartesian space and use inverse kinematics solvers to compute an output in joint position space. The Cartesian selection controller can then enforce limit policies on the results computed by the Cartesian position controllers before passing the computed results in joint position space to a joint position controller in the next lowest level of the stack. For example, a Cartesian position controller can be given three separate goal states in Cartesian coordinates x, y, and z. For some degrees, the goal state could be a position, while for other degrees, the goal state could be a desired velocity.

These functionalities afforded by the software stack thus provide wide flexibility for control directives to be easily expressed as goal states in a way that meshes naturally with the higher-level planning techniques described above. In other words, when the planning process uses a process definition graph to generate concrete actions to be taken, the actions need not be specified in low-level commands for individual robotic components. Rather, they can be expressed as high-level goals that are accepted by the software stack that get translated through the various levels until finally becoming low-level commands. Moreover, the actions generated through the planning process can be specified in Cartesian space in way that makes them understandable for human operators, which makes debugging and analyzing the schedules easier, faster, and more intuitive. In addition, the actions generated through the planning process need not be tightly coupled to any particular robot model or low-level command format. Instead, the same actions generated during the planning process can actually be executed by different robot models so long as they support the same degrees of freedom and the appropriate control levels have been implemented in the software stack.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
generating a three-dimensional representation of a robotic operating environment, wherein the robotic operating environment comprises a robot and a sensor, including:
   generating a first three-dimensional representation of a field of view of the sensor in the robotic operating environment; and
   generating a second three-dimensional representation of a desired observation of an object in the robotic operating environment;
generating a plurality of candidate plans for the robot;
selecting, from the plurality of candidate plans, a particular candidate plan that intersects the first three-dimensional representation of the field of view of the sensor and the second three-dimensional representation of the desired observation of the object; and
causing the robot to execute the particular candidate plan to make the desired observation of the object in the robotic operating environment.

Embodiment 2 is the method of embodiment 1, wherein the sensor is attached to an arm of the robot.

Embodiment 3 is the method of any one of embodiments 1 or 2, wherein selecting, from the plurality of candidate plans, the particular candidate plan comprises:
classifying candidate plans as plans that achieve the desired observation and plans that do not achieve the desired observation; and
selecting the particular candidate plan from plans classified as achieving the desired observation.

Embodiment 4 is the method of any one of embodiments 1-3, wherein generating the plurality of candidate plans comprises:
generating a three-dimensional representation of a volume in which the object is occluded by one or more other objects; and
generating a plurality of candidate plans that avoid placing the sensor within the volume in which the object is occluded.

Embodiment 5 is the method of any one of embodiments 1-4, wherein generating the plurality of candidate plans comprises generating a plan that causes the robot to wait for another robot to move out of the three-dimensional representation of the field of view of the sensor.

Embodiment 6 is the method of any one of embodiments 1-5, wherein:
the three-dimensional representation of a desired observation an object is a three-dimensional volume of the object, and
wherein generating the plurality of candidate plans comprises generating at least one plan for which for each point in a plurality of points on the three-dimensional volume of the object, at least one path of light exists between the point and the sensor, wherein the path of light is a path that light will take during a time interval of the final plan.

Embodiment 7 is the method of embodiment 6, wherein requiring that a path of light exists between the point and the sensor comprises tracing the path of light from the sensor to the point and simulating an effect on the path of light of one or more encounters with respective other objects in the robotic operating environment.

Embodiment 8 is a system comprising: one or more computers and one or more storage devices storing instructions that are operable, when executed by the one or more computers, to cause the one or more computers to perform the method of any one of embodiments 1 to 7.

Embodiment 9 is a computer storage medium encoded with a computer program, the program comprising instructions that are operable, when executed by data processing apparatus, to cause the data processing apparatus to perform the method of any one of embodiments 1 to 7.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method performed by one or more computers, the method comprising:
generating a three-dimensional representation of a robotic operating environment, wherein the robotic operating environment comprises a robot and a sensor, including:
generating a first three-dimensional representation of a field of view of the sensor in the robotic operating environment; and
generating a second three-dimensional representation of a desired observation of an object in the robotic operating environment;
generating a plurality of candidate plans for the robot;
selecting, from the plurality of candidate plans, a particular candidate plan that intersects the first three-dimensional representation of the field of view of the sensor and the second three-dimensional representation of the desired observation of the object; and
causing the robot to execute the particular candidate plan to make the desired observation of the object in the robotic operating environment.

2. The method of claim 1, wherein the sensor is attached to an arm of the robot.

3. The method of claim 1, wherein selecting, from the plurality of candidate plans, the particular candidate plan comprises:
classifying candidate plans as plans that achieve the desired observation and plans that do not achieve the desired observation; and
selecting the particular candidate plan from plans classified as achieving the desired observation.

4. The method of claim 1, wherein generating the plurality of candidate plans comprises:
generating a three-dimensional representation of a volume in which the object is occluded by one or more other objects; and
generating a plurality of candidate plans that avoid placing the sensor within the volume in which the object is occluded.

5. The method of claim 1, wherein generating the plurality of candidate plans comprises generating a plan that causes the robot to wait for another robot to move out of the three-dimensional representation of the field of view of the sensor.

6. The method of claim 1, wherein:
the three-dimensional representation of a desired observation an object is a three-dimensional volume of the object, and
wherein generating the plurality of candidate plans comprises generating at least one plan for which for each point in a plurality of points on the three-dimensional volume of the object, at least one path of light exists between the point and the sensor, wherein the path of light is a path that light will take during a time interval of the final plan.

7. The method of claim 6, wherein requiring that a path of light exists between the point and the sensor comprises tracing the path of light from the sensor to the point and simulating an effect on the path of light of one or more encounters with respective other objects in the robotic operating environment.

8. A system comprising one or more computers and one or more storage devices storing instructions that are operable, when executed by the one or more computers, to cause the one or more computers to perform a method comprising:
generating a three-dimensional representation of a robotic operating environment, wherein the robotic operating environment comprises a robot and a sensor, including:
generating a first three-dimensional representation of a field of view of the sensor in the robotic operating environment; and
generating a second three-dimensional representation of a desired observation of an object in the robotic operating environment;
generating a plurality of candidate plans for the robot;
selecting, from the plurality of candidate plans, a particular candidate plan that intersects the first three-dimensional representation of the field of view of the sensor and the second three-dimensional representation of the desired observation of the object; and
causing the robot to execute the particular candidate plan to make the desired observation of the object in the robotic operating environment.

9. The system of claim 8, wherein the sensor is attached to an arm of the robot.

10. The system of claim 8, wherein selecting, from the plurality of candidate plans, the particular candidate plan comprises:
classifying candidate plans as plans that achieve the desired observation and plans that do not achieve the desired observation; and
selecting the particular candidate plan from plans classified as achieving the desired observation.

11. The system of claim 8, wherein generating the plurality of candidate plans comprises:
generating a three-dimensional representation of a volume in which the object is occluded by one or more other objects; and
generating a plurality of candidate plans that avoid placing the sensor within the volume in which the object is occluded.

12. The system of claim 8, wherein generating the plurality of candidate plans comprises generating a plan that causes the robot to wait for another robot to move out of the three-dimensional representation of the field of view of the sensor.

13. The system of claim 8, wherein:
the three-dimensional representation of a desired observation an object is a three-dimensional volume of the object, and
wherein generating the plurality of candidate plans comprises generating at least one plan for which for each point in a plurality of points on the three-dimensional volume of the object, at least one path of light exists between the point and the sensor, wherein the path of light is a path that light will take during a time interval of the final plan.

14. The system of claim 13, wherein requiring that a path of light exists between the point and the sensor comprises tracing the path of light from the sensor to the point and simulating an effect on the path of light of one or more encounters with respective other objects in the robotic operating environment.

15. One or more non-transitory computer storage media encoded with computer program instructions that when executed by a plurality of computers cause the plurality of computers to perform operations comprising:
generating a three-dimensional representation of a robotic operating environment, wherein the robotic operating environment comprises a robot and a sensor, including:
generating a first three-dimensional representation of a field of view of the sensor in the robotic operating environment; and
generating a second three-dimensional representation of a desired observation of an object in the robotic operating environment;
generating a plurality of candidate plans for the robot;
selecting, from the plurality of candidate plans, a particular candidate plan that intersects the first three-dimensional representation of the field of view of the sensor and the second three-dimensional representation of the desired observation of the object; and
causing the robot to execute the particular candidate plan to make the desired observation of the object in the robotic operating environment.

16. The non-transitory computer storage media of claim 15, wherein the sensor is attached to an arm of the robot.

17. The non-transitory computer storage media of claim 15, wherein selecting, from the plurality of candidate plans, the particular candidate plan comprises:
classifying candidate plans as plans that achieve the desired observation and plans that do not achieve the desired observation; and
selecting the particular candidate plan from plans classified as achieving the desired observation.

18. The non-transitory computer storage media of claim 15, wherein generating the plurality of candidate plans comprises:
generating a three-dimensional representation of a volume in which the object is occluded by one or more other objects; and
generating a plurality of candidate plans that avoid placing the sensor within the volume in which the object is occluded.

19. The non-transitory computer storage media of claim 15, wherein generating the plurality of candidate plans comprises generating a plan that causes the robot to wait for another robot to move out of the three-dimensional representation of the field of view of the sensor.

20. The non-transitory computer storage media of claim 15, wherein:
the three-dimensional representation of a desired observation an object is a three-dimensional volume of the object, and
wherein generating the plurality of candidate plans comprises generating at least one plan for which for each point in a plurality of points on the three-dimensional volume of the object, at least one path of light exists between the point and the sensor, wherein the path of light is a path that light will take during a time interval of the final plan.
